(19) United States
(12) Patent Application Publication
(10) Pub. No.: US 2016/0018551 A1
(43) Pub. Date: Jan. 21, 2016

(54) Device and Method for Tracking a Downhole Tool

(71) Applicant: The Charles Machine Works, Inc., Perry, OK (US)

(72) Inventors: Scott B. Cole, Edmond, OK (US); Brian K. Bailey, Stillwater, OK (US); Larry G. Morse, Perry, OK (US)

(21) Appl. No.: 14/802,500

(22) Filed: Jul. 17, 2015

Related U.S. Application Data
(60) Provisional application No. 62/025,543, filed on Jul. 17, 2014.

(51) Int. Cl. G01V 3/165; G01V 3/16

(52) U.S. Cl. CPC G01V 3/165; G01V 3/16

(57) ABSTRACT

A system for tracking a drill bit. The system uses a self-propelled autonomous receiver. The receiver has an antenna assembly, a processor, and a propulsion system. The antenna assembly detects the magnetic field from an underground transmitter and generates an antenna signal. The processor is programmed to receive the antenna signal and generate a command signal. The propulsion system receives the command signal and moves the receiver to a position above the transmitter. Once in the desired position, the antenna assembly measures the magnetic field to determine the location of the drill bit along borepath.

### CROSS REFERENCE TO RELATED APPLICATION

This application claims the benefit of provisional patent application Ser. No. 62/025,543 filed on Jul. 17, 2014, the entire contents of which are incorporated herein by reference.

### FIELD

The present invention relates generally to the tracking of downhole tools used in horizontal directional drilling operations and specifically to the use of a drone to track the location of a downhole tool.

### SUMMARY

The present invention is directed to a system for tracking a drill bit. The system comprises a drill rig, a drill string, a downhole tool, a dipole magnetic field transmitter, a cutting tool, and a self-propelled autonomous receiver. The drill string has a first end and a second end. The first end is operatively connected to the drill rig. The downhole tool is connected to the second end of the drill string. The dipole magnetic field transmitter is supported by the downhole tool. The cutting tool is connected to the downhole tool. The self-propelled autonomous receiver comprises an antenna assembly, a processor, and a propulsion system. The antenna assembly detects the magnetic field and generates an antenna signal. The processor is programmed to receive the antenna signal and generate a command signal. The propulsion system receives the command signal and moves the receiver to a position above the transmitter.

The present invention is likewise directed to a device for determining the location of a transmitter that transmits a dipole magnetic field. The device comprises a frame, an antenna assembly, and a propulsion system. The frame has a top and a bottom. The antenna assembly is attached to the bottom of the frame. The propulsion system is supported by the frame. The propulsion system moves the frame to a position above the transmitter in response to signal strength and magnetic field orientation measurements taken by the antenna assembly.

Further, the present invention is directed to a method for tracking a dipole magnetic field transmitter. The method comprises providing a receiver having an antenna assembly for detecting the dipole magnetic field in three dimensions and a propulsion system to lift the receiver off the ground. The dipole magnetic field is transmitted and the propulsion system is engaged to lift the receiver into the air. The magnetic field is detected using the antenna assembly and the propulsion system moves the receiver to a position above the transmitter and at a front null point of the magnetic field using the detected magnetic field. The signal strength of the magnetic field and the orientation of the magnetic field are measured in three dimensions using the antenna assembly with the receiver at the null point to determine a location of the transmitter.

### BRIEF DESCRIPTION OF THE DRAWINGS

FIG. 1 is an overall plan view of a horizontal directional drilling operation using a tracker of the present invention.

FIG. 2 is a diagrammatic representation of the tracker of FIG. 1.

FIG. 3 is a block diagram of a tracker constructed to detect and process magnetic field signals from a transmitter.

FIG. 4 is an illustration of flux lines radiating from a transmitter, as depicted in the x-y plane.

### DETAILED DESCRIPTION

The horizontal directional drilling (HDD) industry traditionally uses walk-over tracking techniques to follow the progress of a bore, to find the surface location immediately above the drill bit, and to determine the depth of the drill bit from that surface location. The primary tracking tools are a subsurface transmitter and a hand-carried surface receiver. The transmitter, located in or very near a cutting tool, generally emits a magnetic dipole field created by a single coil dipole antenna. The transmitted dipole field can be used for both location and communication with the above ground receiver. Hand-held receivers are very useful and are appropriate in most drilling operations because the operator can walk along the borepath to track the cutting tool. However, from time-to-time obstructions or restrictions may prevent an operator from walking along the entire borepath. Thus, there remains a need for receivers that are capable of locating a cutting tool when the operator is not able to position himself and the receiver over the cutting tool.

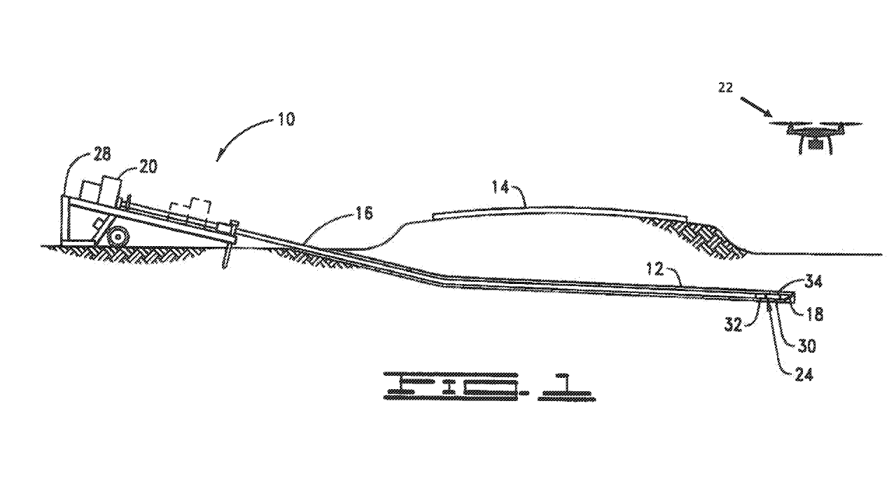

With reference now to the drawings in general and FIG. 1 in particular, there is shown therein an “HDD” system 10 for use with the present invention. FIG. 1 illustrates the usefulness of HDD by demonstrating that a borehole 12 can be made without disturbing an above-ground structure, namely a roadway or walkway as denoted by reference numeral 14. To cut or drill the borehole 12, a drill string 16 carrying a cutting tool such as a drill bit 18 is rotationally driven by a rotary drive system 20. When the HDD system 10 is used for drilling a borehole 12, monitoring the position of the drill bit 18 is critical to accurate placement of the borehole and subsequently installed utilities. The present invention is also useful in tracking the progress of a cutting tool such as a backreamer used to enlarge a borehole. The present invention is directed to a system 22 and method for tracking and monitoring a downhole tool 24 during an HDD operation.

The HDD system 10 of the present invention is suitable for near-horizontal subsurface placement of utility services, for example under the roadway 14, building, river, or other obstacle. The tracking system 22 for use with the HDD system 10 is an airborne self-propelled autonomous receiver particularly suited for providing an accurate three-dimensional locate of the downhole tool assembly 24 from above ground. The locating and monitoring operation with the present receiver system 22 is advantageous in that it may be accomplished in a single operation that does not require the operator to stand on the borepath or above the downhole tool. The present invention also permits the position of the downhole tool assembly 24 to be monitored without requiring the tracking system 22 be placed directly over a transmitter in the downhole tool assembly. These and other advantages associated with the present invention will become apparent from the following description of the preferred embodiments.

With continued reference to FIG. 1, the HDD system 10 comprises the drill rig 28 having a rotary drive system 20 operatively connected to the first end of the drill string 16. The downhole tool 24 is connected to the second end of the drill string 16. The downhole tool 24 preferably comprises an electronics package 30 and has a cutting tool such as a slant-faced drill bit 18 connected to its downhole end. In a preferred embodiment the transmitter is supported within a housing of the downhole tool 24. However, an alternative transmitter as disclosed in co-pending U.S. patent application Ser. No. 14/733,340 may be used without departing from the spirit of the present invention. The electronics package 30 comprises a transmitter 32 for emitting a signal through the ground. Preferably the transmitter 32 is supported by the downhole tool 24 and comprises a dipole antenna that emits a dipole magnetic field. The electronics package 30 may also comprise a plurality of sensors 34 for detecting operational characteristics of the downhole tool 24 and the drill bit 18. The plurality of sensors 34 may generally comprise sensors such as a roll sensor to sense the roll position of the drill bit 18, a pitch sensor to sense the pitch of the drill bit, a temperature sensor to sense the temperature in the electronics package 30, and a voltage sensor to indicate battery status. The information detected by the plurality of sensors 34 is preferably communicated from the downhole tool assembly 24 on the signal transmitted by the transmitter 32 using modulation or other known techniques.

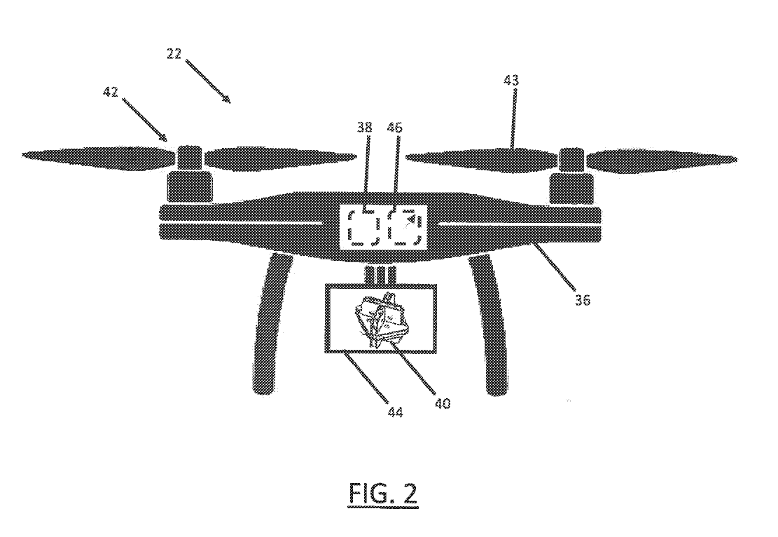

With reference now to FIG. 2, shown therein is a preferred embodiment of the receiver 22 of the present invention. The receiver 22 comprises a frame 36, a computer processor 38, and an antenna assembly 40 supported by the frame. The processor 38 is supported on the frame 36 and operatively connected to the antenna assembly 40. The frame 36 is preferably of lightweight construction and capable of being lifted and maneuvered with a propulsion system 42 supported by the frame and operatively connected to the processor 38. The propulsion system 42 may comprises one or more rotors 43 used to lift the frame into the air. The receiver shown in FIG. 2 comprises a quadcopter having a housing 44 for supporting the antenna assembly 40. While a quadcopter is shown to illustrate the usefulness of the present invention, one skilled in the art will appreciate any remotely controlled or autonomous aircraft capable of lifting, hovering, landing, and moving the antenna assembly will be an acceptable vehicle for moving the antenna assembly.

The antenna assembly 40 is supported on the frame 36 and is preferably adapted to measure the total magnetic field emitted by the dipole transmitter 32. The antenna assembly 40 may comprise three mutually orthogonal antennas which measure the magnetic field along their specific axis of sensitivity. Each of the three orthogonal antenna signals is squared, summed, and then the square root is taken to obtain the total field. This calculation assumes the sensitivities of each antenna are the same and that the center of each antenna is coincident with the other two such that the antenna arrangement is measuring the total field at a single point in space. As shown in FIG. 2 the tri-axial antenna may comprises three antenna coils wound around a frame in channels formed in support structure. The structure and function of such an antenna is described more fully U.S. Pat. No. 7,786,731, issued to Cole et al., the contents of which are fully incorporated herein. While wound antenna coils are shown in FIG. 2, one skilled in the art will appreciate that printed circuit board antennas like those disclosed in co pending U.S. patent application Ser. No. 14/750,553, or traditional ferrite rod antennas may be used without departing from the spirit of the invention. Additionally, more than one antenna assembly 40 may be supported by the frame as disclosed in U.S. patent application Ser. No. 14/137,379, the contents of which are incorporated fully herein by this reference.

A processor 38 may be supported on the frame and programmed to determine a distance between the antenna assembly 40 and the transmitter 32 (FIG. 1) based on the signal strength and magnetic field orientation measurements taken by the antenna assembly. Alternatively, the processor 38 may be replaced by a communication system adapted to transmit the measurements taken by the antenna assembly 40 to a processor disposed at a location remote from the receiver 22 such as at drill rig 28. Such an arrangement may be preferable if the weight of the receiver components supported by the frame is of a concern.

An altimeter 46 may be supported by the frame 36 and used to determine an altitude (height above round level) of the frame. The altimeter 46 may comprise a traditional altimeter or ultrasonic or Ultra Wide Band (UWB) sensors. Alternatively, a global positioning system may be used to determine the position and altitude of the receiver. Knowing the altitude of the frame 36, and thus the antenna assembly 40, is important for determining the depth of the transmitter 32 (FIG. 1) below ground. The depth of the transmitter 32 is determined using the altitude of the receiver and the distance between the antenna assembly 40 and the transmitter. In other words, when the antenna assembly is directly over the transmitter the altitude is subtracted from the distance between the receiver and the transmitter to determine a depth of the transmitter. This function is preferably performed by the processor and communicated to a hand-held remote display (not shown) or via a remote display (not shown) at the drill rig 28.

The processor 38 is programmed to transmit a command signal to the propulsion system 42. The command signal instructs the propulsion system 42 and causes the receiver to move to a position above the transmitter. The command signal may direct the frame to move to a null point of the magnetic field above and in front of the transmitter in a manner yet to be described.

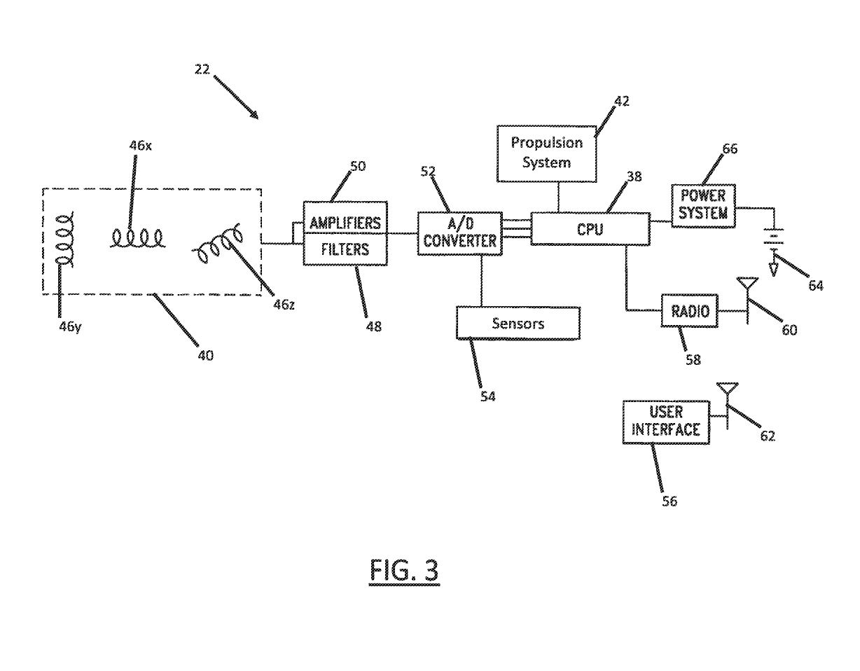

With reference now to FIG. 3, shown therein is a block diagram of the preferred embodiment of the receiver 22 of the present invention. The antenna assembly 40, as described earlier, measures changes in the magnetic field. A change in the magnetic field sensed will result in a voltage being induced in response to the transmitter's magnetic field. The voltages from the antennas 46x, 46y, and 46z are sent to filter 48 and amplifier 50. Filter 48 eliminates the effects of other signals received by the antennas 46 from local noise sources. Amplifier 50 increases the signal received by the antennas 46x, 46y, and 46z. An A/D converter 52 is used to convert analog waveform information into digital data.

The digital data from the A/D converter 52 is then sent to the central processor 38 (CPU) to calculate the location of the transmitter 32 (FIG. 1) relative to the receiver 22. The CPU 38 may comprise a digital signal processor (DSP) and a microcontroller. The CPU 38 decodes the information from the A/D converter 52 and performs calculations to determine the location of the transmitter. The CPU 38 may also discern information transmitted on the magnetic field, to determine the battery status, pitch, roll, and other information about the downhole tool assembly 24.

The receiver 22 may comprise one or more sensors 54 used to sense operational information about the receiver 22. For example, an altimeter 46 (FIG. 2), one or more accelerometers, or other known inclination and orientation sensors or magnetic compasses, may provide information concerning the roll or tilt of the receiver 22. An orientation sensor may be used to determine an orientation of the frame 36 relative to a reference orientation. Commonly, the reference orientation would comprise the frame disposed in a level orientation relative to the horizon. Information from the sensors 54 is provided to the A/D converter 52 and to the CPU 38 where the DSP may make calculations to compensate for the receiver 22 not being level.

In the preferred embodiment a user interface 56 having plurality of buttons, joysticks, and other input devices may be used to control the receiver 22. The operator can input information for use by the CPU 38 through the user interface 56. Information entered through the user interface 56 or determined or used by the CPU 38 may be displayed to the operator on a visual display (not shown) screen at the receiver. The receiver 22 also comprises a radio 58 having an antenna 60 for transmitting information from the CPU 38 to the remote user interface 56 via antenna 62, such as at the drilling machine 10.

The receiver 22 is preferably powered by a battery assembly 64 and power regulation system 66. The battery assembly 64 may comprise rechargeable batteries. The power regulation system 66 may comprise a linear regulator or switch mode regulator to provide power to the various components of the receiver 22.

The processor 38 receives the magnetic field measurements taken by antennas 46x, 46y, and 46z and processes them as disclosed in U.S. Pat. No. 7,786,731 to determine the location of the transmitter or alternatively to direct the receiver to the transmitter. However, instead of translating the inputs into directional indicators used to direct the operator to certain points in the magnetic field, the processor issues command signals that direct the propulsion system 42 to move the receiver in a desired direction. The processor may directly interface with the propulsion system controls or it may transmit the antenna signals received from the antenna assembly 40 to a remote processor via a wireless communication link adapted to control movement and position of the receiver. Use of a processor remote from the receiver will reduce the weight of the receiver and reduce power consumption from the batteries 64.

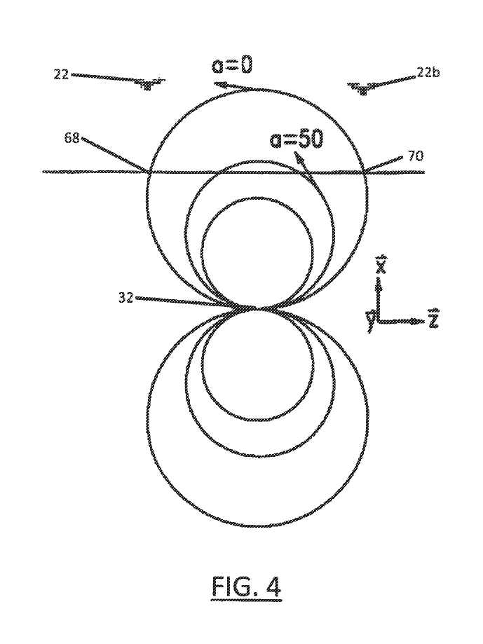

Referring now to FIG. 4, there is shown therein a graphical depiction of flux lines radiating from the transmitter 32 in the x-z plane. Assuming the pitch of the receiver 22 is 0, note that the angle α [symbol] 0 as z [symbol] 0. The processor 38 detects this angle and commands the propulsion system 42 to move the receiver 22 until it is located above a front null point 68 (a point wherein the magnetic field is completely vertical). Using the antenna assembly 40 the front null point is easily determined by detecting a signal strength measurement of zero with antenna 46y. At this point, the receiver will be located on the borepath above and in front of the transmitter. Field strength measurements may be taken at the front null point with the 46x and 46z antennas to determine the direct distance to the transmitter. Using the direct distance and the distance between the receiver 22 and the ground, the depth of the transmitter can be determined.

With the present invention, improved methods for directing and drilling a horizontal directional borehole 12 are also possible. For example, a receiver having an antenna assembly for detecting the dipole magnetic field in three dimensions and a propulsion system to lift the receiver off the ground is provided. The dipole magnetic field is transmitted from the transmitter and the propulsion system is engaged to lift the receiver into the air. The antenna assembly continuously detects the magnetic field. Signal strength and field orientation measurements taken by the antenna assembly are used by the processor to determine a location of the receiver within the magnetic field and to direct the receiver to a position above the transmitter that is within a cone having a vertex at the transmitter, a vertical axis, and boundaries defined by the front and back null points. At the front null point the processor may take measurements of the signal strength of the field to determine a location, including the depth, of the transmitter. Measurements may be taken with the receiver hovering above the ground. Alternatively, the receiver may land to take field strength measurements and then take-off to move to a new location. Landing to measure the magnetic field may be advantageous to reduce noise effect from the propulsion system when locating the transmitter or to steady the receiver if high winds are present.

In an improved method of tracking the downhole tool, the transmitter may be moved along the desired borepath and the receiver may be programmed to automatically move with the transmitter to maintain its position at the front null point 68 and provide periodic depth and location measurements as the boring operation advances.

A second receiver 22b may also be utilized in concert with the receiver 22 to track the downhole tool as it progresses along the borepath. In such system, the second receiver 22b may be programmed to find and position itself at a back null point 70 with the receiver 22 positioned at the front null point 68. Onboard sensors or GPS may be used to determine the direct distance between the receiver 22 and second receiver 22b. With the receivers positioned at the null points 68 and 70 the processer may determine the depth of the transmitter which is equal to the distance between the receivers divided by the square root of 2 (assuming the pitch of both is zero).

Various modifications can be made in the design and operation of the present invention without departing from its spirit. Thus, while the principle preferred construction and modes of operation of the invention have been explained in what is now considered to represent its best embodiments, it should be understood that within the scope of the appended claims, the invention may be practiced otherwise than as specifically illustrated and described.

What is claimed is:

1. A system for tracking a drill bit, the system comprising:
a drill rig;
a drill string having a first end and a second end, the first end is operatively connected to the drill rig;
a downhole tool connected to the second end of the drill string;
a dipole magnetic field transmitter supported by the downhole tool;
a drill bit connected to the downhole tool; and
a self-propelled autonomous receiver comprising:
an antenna assembly to detect the magnetic field and generate an antenna signal;
a processor programmed to receive the antenna signal and generate a command signal; and
a propulsion system to receive the command signal and move the receiver to a position above the transmitter.

2. The system of claim 1 wherein the position above the transmitter is within a cone having a vertex as the transmitter, a vertical axis, and boundaries defined by a front null point and a back null point.

3. The system of claim 1 wherein the antenna assembly comprises a plurality of antennas, each of the plurality of antennas disposed on a different axis.

4. The system of claim 1 wherein the antenna assembly comprises three mutually orthogonal antennas.

5. The system of claim 1 further comprising an altimeter to determine an altitude of the receiver above ground level.

6. The system of claim 4 wherein the command signal directs the receiver to move to a null point of the magnetic field above and in front of the transmitter.

7. The system of claim 1 wherein in the processor uses a signal strength of the magnetic field detected by the antenna assembly to determine a distance between the receiver and the transmitter.

8. The system of claim 7 further comprising an altimeter to determine an altitude of the receiver above ground level, wherein the processor determines a depth of the transmitter below ground using the altitude of the receiver and the distance between the receiver and the transmitter.

9. The system of claim 1 wherein the propulsion system comprises a helicopter rotor.

10. A device for determining the location of a transmitter that transmits a dipole magnetic field, the device comprising:
a frame having a top and a bottom;
an antenna assembly attached to the bottom of the frame; and
a propulsion system supported by the frame;
wherein the propulsion system moves the frame to a position above the transmitter in response to signal strength and magnetic field orientation measurements taken by the antenna assembly.

11. The device of claim 10 further comprising a processor programmed to determine a distance between the antenna assembly and the transmitter based on the signal strength and magnetic field orientation measurements taken by the antenna assembly.

12. The device of claim 11 wherein the processor is further programmed to transmit a command signal to the propulsion system, wherein the command signal engages the propulsion system to move the frame above the transmitter.

13. The device of claim 11 further comprising an altimeter to determine an altitude of the frame above ground level, wherein the processor determines a depth of the transmitter below ground using the altitude of the receiver and the distance between the antenna assembly and the transmitter.

14. The device of claim 13 wherein the altimeter comprises an ultrasonic sensor.

15. The device of claim 10 wherein the propulsion system comprises a helicopter rotor.

16. The device of claim 11 wherein the command signal directs the frame to move to a null point of the magnetic field above and in front of the transmitter.

17. The device of claim 10 wherein the antenna assembly comprises three mutually orthogonal antennas.

18. The device of claim 13 further comprising an orientation sensor supported on the frame to determine an orientation of the frame relative to a reference orientation.

19. A method for tracking a dipole magnetic field transmitter, the method comprising:
providing a receiver having an antenna assembly for detecting the dipole magnetic field in three dimensions and a propulsion system to lift the receiver off the ground;
transmitting the dipole magnetic field;
engaging the propulsion system to lift the receiver into the air;
detecting the magnetic field using the antenna assembly;
moving the receiver with the propulsion system to a position above the transmitter and at a front null point of the magnetic field using the detected magnetic field; and
measuring the signal strength of the magnetic field and the orientation of the magnetic field in three dimensions using the antenna assembly with the receiver at the null point to determine a location of the transmitter.

20. The method of claim 19 further comprising;
moving the transmitter; and
automatically moving the receiver with the null point as the transmitter is moved.

21. The method of claim 19 further comprising:
positioning a second receiver in the air above a back null point of the magnetic field;
determining a distance between the receiver and the second receiver; and
determining a depth of the transmitter below ground based on the distance between the receiver and the second receiver.
